(19) United States
(12) Patent Application Publication
(10) Pub. No.: US 2007/0124587 A1
(43) Pub. Date: May 31, 2007

(54) Re-Keying in a Generic Bootstrapping Architecture Following Handover of a Mobile Terminal

(75) Inventors: Govindarajan Krishnamurthi, San Diego, CA (US); Tat Keung Chan, San Diego, CA (US); Pekka Laitinen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/533,861

(22) Filed: Sep. 21, 2006

Related U.S. Application Data
(60) Provisional application No. 60/719,002, filed on Sep. 21, 2005.

(51) Int. Cl. H04L 9/00

(52) U.S. Cl. 713/168

(57) ABSTRACT

An apparatus for re-keying a mobile terminal in a foreign network includes a processor. The processor is configured to receive, at the apparatus which is physically located in the foreign network, a request for re-keying from the mobile terminal in the foreign network. The processor is also configured to translate the request for transmission to a home network of the mobile terminal and to transmit the translated request to a bootstrapping server function of the home network.

### CROSS REFERENCE TO RELATED APPLICATION

This application claims the benefit of U.S. Provisional Application No. 60/719,002, filed Sep. 21, 2005, the contents of which are incorporated herein in their entirety.

### TECHNOLOGICAL FIELD

Embodiments of the present invention relate generally to wireless technology and, more particularly, relate to the secure authentication of a mobile terminal following a handover process.

### BACKGROUND

Security of mobile terminals, such as portable communication devices (PCDs) (e.g., cellular telephones), portable digital assistants (PDAs), laptop computers, or any suitable device that is capable of communicating with a wireless network, is increasingly important to mobile terminal users. Security algorithms are often employed to achieve security between a mobile terminal and another network entity. These security algorithms often rely upon a secret that is shared between the mobile terminal and the other network entity that permits the mobile terminal to be authenticated. Typically, this shared secret is embodied in the form of a key. In order to further enhance the security, many security algorithms require re-keying at various intervals. Re-keying is a process in which new keys are established such that future communications may be protected with the new keys. If a third party obtained one set of keys and therefore compromised the security between the mobile terminal and the other network entity, re-keying would prevent the third party from continuing to be able to access the communication with the mobile terminal once a new set of keys has been established, thereby limiting temporally the security breach.

A Generic Bootstrapping Architecture (GBA) is a framework architecture that allows bootstrapping of a security key between a mobile terminal and a home network, which can then be used to further derive security keys for use between the mobile terminal and a network application server. Recently, GBA has been thought of as a mechanism to provide keys for securing internet protocol (IP) level handovers. For example, Third Generation Partnership Project 2 Wireless Local Area Networks (3GPP2-WLAN) and Third Generation Partnership Project Wireless Local Area Networks (3GPP-WLAN) working groups are developing mechanisms for mobile terminals to be authenticated securely when handing over from one network to another.

The GBA includes a bootstrapping server function (BSF) that is located in the home network of a mobile terminal. The BSF allows the bootstrapping of a shared key, Ks, between the mobile terminal and the BSF. This Ks is generated during the bootstrapping step based on a long-term shared secret that is shared between the mobile terminal and the home network. The long-term shared secret is a very secure code stored securely in the mobile terminal and the home network. The Ks can then be used to derive a further application key, called Ks_NAF, to be used between the mobile terminal and an application server in the network, called a network application function (NAF) in GBA terminology. Ks_NAF is application server specific, i.e., each application server will have a different application key Ks_NAF derived from the Ks, thus ensuring that different application servers do not share the same application key. To ensure maximum security, Ks and all application keys Ks_NAF's derived from it have a limited lifetime and when the lifetime expires, a new bootstrapping is required to generate a new Ks. Thus, the term re-keying in the GBA environment refers to the performance of a bootstrapping procedure to facilitate creation of a new shared secret, Ks, and subsequently new Ks_NAF's. These application keys may then be used between the mobile terminal and an individual NAF to achieve any security services required (e.g. these keys can be used for mutual authentication between the mobile terminal and the NAF, and/or used for encryption/decryption of data, and/or to derive further keys, etc.)

If the GBA is used to authenticate a mobile terminal following handover from the home network to another and re-keying is required due to expiration of the current shared secret, the re-keying must be done while the mobile terminal is physically located in a network, i.e., a foreign network, other than the home network. According to current GBA specifications, the mobile terminal must establish an IP connection with the BSF in its home network and perform a bootstrapping procedure in order to establish the new Ks. However, when a mobile terminal is in a foreign network, for example, a wireless local area network (WLAN) or a WiMAX network, an IP connection may not be allowed until the mobile terminal is authenticated by the home network. In such a case, if Ks has expired, authentication using the GBA will not be possible by the home network without re-keying which, as stated above, requires an IP connection with the BSF. The mobile terminal is thus left in the untenable position of needing an active key to permit the mobile terminal to be authenticated using the GBA by the home network, but being unable to communicate with the home network in order to go through the re-keying process that would be required to obtain an active key. Thus, there is a need to develop a means by which a mobile terminal may be authenticated by the GBA after a handover to a foreign network even if the current keys have expired and re-keying is required.

### BRIEF SUMMARY

A system, apparatus and computer program code are therefore provided for re-keying of a mobile terminal in a foreign network even if the current keys are expired and re-keying is required. In accordance with one aspect of embodiments of the present invention, the system, apparatus and computer program code may be embodied in an authentication node disposed in the foreign network. The authentication node of this embodiment is configured to parse an incoming bootstrap request message from a mobile terminal and forward a bootstrap request to a bootstrapping server function (BSF) of a home network of the mobile terminal.

In one exemplary embodiment, a computer program product for re-keying a mobile terminal in a foreign network is provided. The computer program product includes a storage medium, readable by a processing circuit, storing instructions for execution by the processing circuit for receiving a request from the mobile terminal to commence a bootstrapping procedure in a first protocol, and transmitting the request to a bootstrapping server function of a home network of the mobile terminal in a second protocol.

In another exemplary embodiment, an authentication node disposed in or otherwise in communication with a foreign network comprises a memory device and a processor. The memory device is capable of storing instructions and is readable by the processor. The processor is capable of executing the instructions. The instructions comprise a receipt instruction and a transmit instruction. The receipt instruction enables the authentication node to receive a request from a mobile terminal to commence a bootstrapping procedure in a first protocol. The transmit instruction enables the authentication node to transmit the request to a bootstrapping server function of a home network of the mobile terminal in a second protocol.

In another exemplary embodiment, a method for re-keying a mobile terminal in a foreign network is provided. The method includes receiving a request for re-keying a mobile terminal in a foreign network, translating the request for transmission to a home network of the mobile terminal, and transmitting the translated request to a bootstrapping server function of the home network.

In another exemplary embodiment, a computer program product for re-keying a mobile terminal in a foreign network is provided. The computer program product includes at least one computer-readable storage medium having computer-readable program code portions stored therein. The computer-readable program code portions include first, second and third executable portions. The first executable portion is for receiving a request for re-keying a mobile terminal in a foreign network. The second executable portion is for translating the request for transmission to a home network of the mobile terminal. The third executable portion is for transmitting the translated request to a bootstrapping server function of the home network.

In another exemplary embodiment, an apparatus for re-keying a mobile terminal in a foreign network is provided. The apparatus includes a processor configured to receive, at the apparatus which is physically located in the foreign network, a request for re-keying from the mobile terminal in the foreign network. The processor is also configured to translate the request for transmission to a home network of the mobile terminal and to transmit the translated request to a bootstrapping server function of the home network.

In another exemplary embodiment, a system for re-keying a mobile terminal in a foreign network is provided. The system includes a mobile terminal, a bootstrapping server function and an authentication node. The mobile terminal is physically located in a foreign network. The bootstrapping server function is in communication with a home network of the mobile terminal. The authentication node is in communication with the foreign network. The authentication node is configured to receive a request for re-keying from the mobile terminal, to translate the request for transmission to the bootstrapping server function, and to transmit the translated request to the bootstrapping server function

In another exemplary embodiment, an apparatus for re-keying a mobile terminal in a foreign network is provided. The apparatus includes means for receiving a request for re-keying a mobile terminal in a foreign network, means for translating the request for transmission to a home network of the mobile terminal, and means for transmitting the translated request to a bootstrapping server function of the home network.

Embodiments of the invention provide a system, apparatus and computer program product for translating a bootstrap request from a mobile terminal to a home network. As a result, re-keying of a mobile terminal may occur in a foreign network even if current keys are expired.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a network model according to an exemplary embodiment;

FIG. 2 is a schematic block diagram of a wireless communications system according to an exemplary embodiment of the present invention;

FIG. 3 is a schematic block diagram more particularly illustrating a mobile terminal, in accordance with one embodiment of the invention;

FIG. 4 is a flowchart illustrating the operations for re-keying a mobile terminal while in communication with a foreign network, in accordance with one embodiment of the invention;

FIG. 5 is a schematic block diagram illustrating bootstrapping based on Signaling Message Encryption Key (SMEKEY) using Extensible Authentication Protocol (EAP) according to an exemplary embodiment of the present invention;

FIG. 6 is a schematic block diagram illustrating bootstrapping based on mobile node Authentication, Authorization, and Accounting (MN-AAA) Key using EAP according to an exemplary embodiment of the present invention; and

FIG. 7 is a flowchart illustrating the operations for re-keying a mobile terminal while in communication with a foreign network, in accordance with one embodiment of the invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

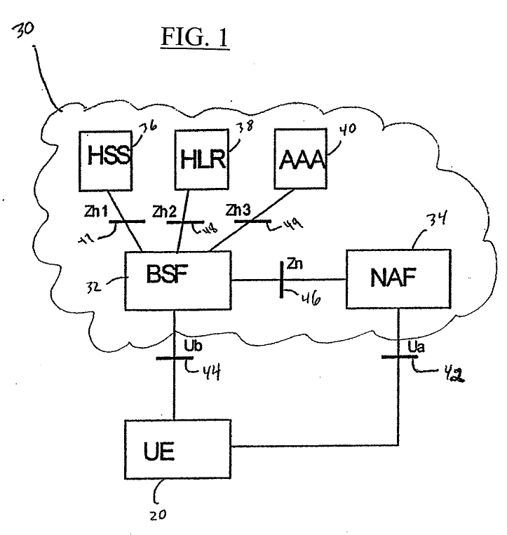

FIG. 1 illustrates a block diagram of a simple network model that would benefit from embodiments of the present invention. As shown, a mobile terminal 20 (designated User Equipment (UE 20)) is shown to be in communication with a home network 30, such as a cellular network. While a mobile telephone is a common example of a mobile terminal, a mobile telephone is merely illustrative of one type of mobile terminal that would benefit from embodiments of the present invention and, therefore, should not be taken to limit the scope of the present invention. For example, other types of mobile terminals, such as portable digital assistants (PDAs), pagers, laptop computers and other types of voice and text communications systems, can readily employ embodiments of the present invention. Moreover, embodiments of the present invention will be primarily described in conjunction with mobile communications applications. But other embodiments of the present invention can be utilized in conjunction with a variety of other applications, both in the mobile communications industries and outside of the mobile communications industries.

Although not shown in FIG. 1, in the embodiment in which the home network 30 is a cellular network, the mobile terminal 20 generally includes an antenna for transmitting signals to and for receiving signals from one or more base transceiver stations (BTS's) (also termed base stations). The BTS is a part of one or more cellular or mobile networks that each includes elements required to operate the network. A BTS acts as the interface between a network and a mobile node, in that the BTS converts digital data into radio signals and converts radio signals into digital data. Each BTS generally has an associated radio tower or antenna and communicates with various access terminals using radio links. In particular, BTSs communicate with various access terminals through the modulation and transmission of sets of forward signals, while BTSs receive and demodulate sets of reverse signals from various access terminals that are engaged in a wireless network activity (e.g., a telephone call, Web browsing session, etc.).

BTSs generally connect to one or more base station controllers (BSCs) (e.g., using un-channelized Ti facilities or direct cables, although this is not required). The connection between a BTS and a BSC may use, for example, un-channelized Ti facilities or direct cables. BSCs are used to interface (aggregate) all radio frequency (RF) traffic arriving from the antennas of the BTSs, and to provide this traffic to a mobile switching center (MSC). As known in the art, BSCs are generally responsible for managing the radio resources for one or more BTSs. For example, BSCs may handle radio-channel setup, frequency hopping, and handovers. Moreover, the MSC is responsible for providing the interface between the radio access network (RAN), which includes BTSs, BSCs, and packet control functions (PCFs), and a public switched telephone network (PSTN). In particular, MSC 18 controls the signaling required to establish calls, and allocates RF resources to BSCs and PCFs. In operation, the MSC is capable of routing calls, data or the like to and from mobile stations when those mobile stations are making and receiving calls, data or the like. The MSC can also provide a connection to landline trunks when mobile stations are involved in a call.

PCFs are used to route IP packet data between mobile terminals (when within range of one of BTSs) and a packet data service node (PDSN). A PDSN, in turn, may be used to provide access to one or more IP networks, such as, for example, the Internet, intranets, applications servers, or corporate virtual private networks (VPNs). In this manner, a PDSN acts as an access gateway.

Although not every element of every possible network is shown and described herein, it should be appreciated that the mobile terminal 20 may be coupled to one or more of any of a number of different networks using one or more of any of a number of different modes (also referred to herein as protocols). In this regard, the network can be capable of supporting communication in accordance with any one or more of a number of first-generation (1G), second-generation (2G), 2.5G and/or third-generation (3G) mobile communication protocols or the like. More particularly, the mobile terminal may be coupled to a network capable of supporting communication in accordance with 2G wireless communication protocols IS-136 (TDMA), GSM, and IS-95 (CDMA). Also, for example, the network can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as CDMA2000 and Universal Mobile Telephone System (UMTS) network employing Wideband Code Division Multiple Access (WCDMA) radio access technology. Additionally, the network may be capable of supporting wide area network (WAN) communications, such as WLAN (IEEE 802.11) or WiMAX (802.16). Some narrow-band AMPS (NAMPS), as well as TACS, network(s) may also benefit from embodiments of the invention, as should dual or higher mode mobile stations (e.g., digital/analog or TDMA/CDMA/analog phones).

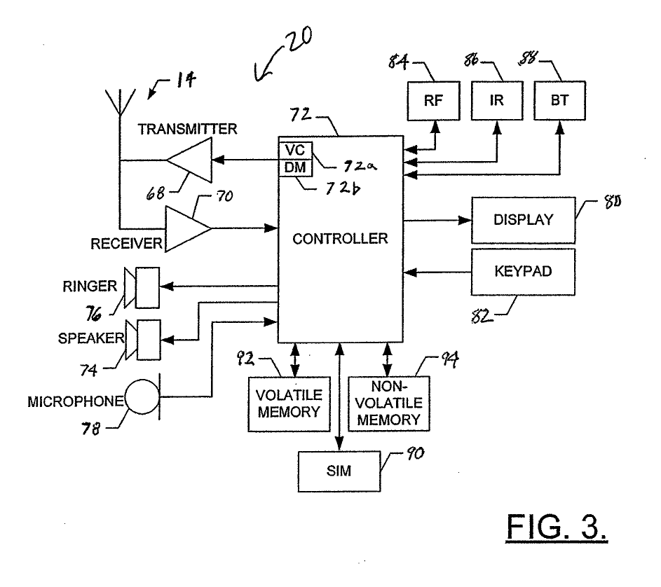

Reference is now made to FIG. 3, which illustrates one type of mobile terminal 20, a mobile telephone, which would benefit from embodiments of the invention. It should be understood, however, that the mobile terminal illustrated and hereinafter described is merely illustrative of one type of mobile terminal that would benefit from embodiments of the invention and, therefore, should not be taken to limit the scope of embodiments of the invention.

The mobile terminal 20 includes various means for performing one or more functions in accordance with exemplary embodiments of the invention, including those more particularly shown and described herein. It should be understood, however, that the mobile terminal may include alternative means for performing one or more like functions, without departing from the spirit and scope of embodiments of the invention. More particularly, for example, as shown in FIG. 3, in addition to an antenna 14, the mobile terminal 20 can include a transmitter 68, receiver 70, and controller 72 or other processor that provides signals to and receives signals from the transmitter and receiver, respectively. These signals include signaling information in accordance with the air interface standard of the applicable cellular system, and also user speech and/or user generated data. In this regard, the mobile terminal can be capable of operating with one or more air interface standards, communication protocols, modulation types, and access types. More particularly, the mobile terminal can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile terminal may be capable of operating in accordance with 3G wireless communication protocols such as CDMA2000 or UMTS network employing WCDMA radio access technology. Additionally, the mobile terminal may be capable of operating in accordance with wide area network (WAN) communication protocols, such as WLAN (IEEE 802.11) or WiMAX (802.16). Some NAMPS, as well as TACS, mobile terminal may also benefit from the teaching of this invention, as should dual or higher mode phones (e.g., digital/analog or TDMA/CDMA/analog phones).

It is understood that the controller 72 includes the circuitry required for implementing the audio and logic functions of the mobile terminal 20. For example, the controller may be comprised of a digital signal processor device, a microprocessor device, and various analog-to-digital converters, digital-to-analog converters, and other support circuits. The control and signal processing functions of the mobile node are allocated between these devices according to their respective capabilities. The controller can additionally include an internal voice coder (VC) 72a, and may include an internal data modem (DM) 72b. Further, the controller may include the functionality to operate one or more client software programs such as those indicated above, which may be stored in memory (described below).

The mobile terminal 20 also comprises a user interface including a conventional earphone or speaker 74, a ringer 76, a microphone 78, a display 80, and a user input interface, all of which are coupled to the controller 72. Although not shown, the mobile terminal can include a battery for powering the various circuits that are required to operate the mobile terminal, as well as optionally providing mechanical vibration as a detectable output. The user input interface, which allows the mobile node to receive data, can comprise any of a number of devices allowing the mobile terminal to receive data, such as a keypad 82, a touch display (not shown), a joystick (not shown) or other input device. In embodiments including a keypad, the keypad includes the conventional numeric (0-9) and related keys (#, *), and other keys used for operating the mobile node.

The mobile terminal 20 can also include one or more means for sharing and/or obtaining data. For example, the mobile node can include a short-range radio frequency (RF) transceiver or interrogator 84 so that data can be shared with and/or obtained from electronic devices in accordance with RF techniques. The mobile terminal can additionally, or alternatively, include other short-range transceivers, such as, for example an infrared (IR) transceiver 86, and/or a Bluetooth (BT) transceiver 88 operating using Bluetooth brand wireless technology developed by the Bluetooth Special Interest Group. The mobile terminal can therefore additionally or alternatively be capable of transmitting data to and/or receiving data from electronic devices in accordance with such techniques.

The mobile terminal 20 can further include memory, such as a subscriber identity module (SIM) 90, a removable user identity module (R-UIM), a smart card, or the like, which typically stores information elements related to a mobile subscriber. In addition to the SIM, the mobile node can include other removable and/or fixed memory. In this regard, the mobile node can include volatile memory 92, such as volatile Random Access Memory (RAM) including a cache area for the temporary storage of data. The mobile node can also include other non-volatile memory 94, which can be embedded and/or may be removable. The non-volatile memory can additionally or alternatively comprise an EEPROM, flash memory or the like. The memories can store any of a number of software applications, instructions, pieces of information, and data, used by the mobile node to implement the functions of the mobile terminal.

With reference again to FIG. 1 and as known to those skilled in the art, the home network 30 includes a bootstrap server function (BSF) 32, a home subscriber system (HSS) 36, a home location register (HLR) 38 and an authentication, authorization and accounting (AAA) server 40. The HSS 36 contains a complete set of a user's GBA security settings. The HLR 38 contains subscriber information used in handing over calls to networks other than the home network 30. The AAA server 40 dictates the computer resources that users have access to and keeps track of user activity over a network. It should be noted, however, that an alternative exemplary embodiment of a network model may not include one or more of the above listed components and/or may include additional components. In 3GPP2, GBA bootstrapping may be based on long term shared secret stored in the HSS 36 (in which case, AKA (Authentication and Key Agreement) is used), or the HLR 38 (in which case CAVE is used), or the AAA server 40 (in which case Mobile IP authentication is used). In 3GPP, GBA bootstrapping is based on long term shared secret stored in the HSS 36 (and AKA is used). In addition, a network application function (NAF) 34 exists either in the home network (as shown, for example, in FIG. 1) or foreign network.

In the network model 10, communication between various elements is established via interfaces. For example, the UE 20 communicates with the NAF 34 via a first interface (Ua) 42. The UE 20 communicates with the BSF 32 via a second interface (Ub) 44. The BSF 32 communicates with the NAF 34 via a third interface (Zn) 46. The BSF 32 communicates with the HSS 36, the HLR 38 and the AAA 40 via a fourth interface (Zh1) 47, a fifth interface (Zh2) 48 and a sixth interface (Zh3) 49, respectively. Thus, in order to commence a bootstrap procedure, the UE 20 submits a bootstrap request to the BSF 32 via the second interface Ub 44, typically as an IP message. Upon receipt of the bootstrap request, the BSF 32 and the UE 20 continue with the bootstrapping procedure over the Ub interface 46, which comprises a message exchange which may involve two or more roundtrips between the UE 20 and the BSF 32, and involves mutual authentication between the UE 20 and the home network 30. The bootstrapping procedure results in a new shared secret Ks (with an associated Bootstrapping Transaction ID (B-TID) and a lifetime) at both the UE 20 and BSF 32. Subsequently, when the UE 20 attempts to communicate with the NAF 34 via the first interface Ua 42, the UE 20 can derive the specific Ks_NAF from the Ks (using a predefined Key Derivation function (KDF), based on information including an identity of the NAF 34). The UE 20 conveys the B-TID to the NAF 34, which will then contact the BSF 32 via the third interface Zn 46. The BSF 32 then derives the Ks_NAF the same way as the UE 20, and returns the Ks_NAF back to the NAF 34. Subsequent communications conducted by the application executed by the UE 20 and the NAF 34 can then be secured by means of the new Ks_NAF.

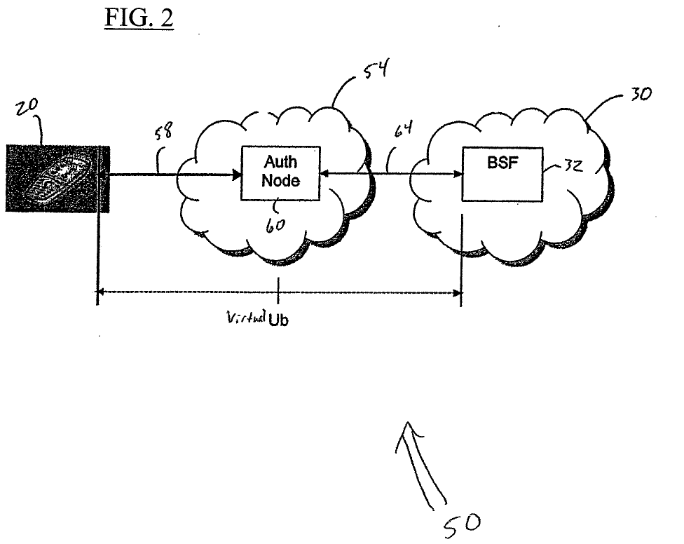

FIG. 2 is a schematic block diagram of a wireless communications system 50 according to an exemplary embodiment of the present invention. FIG. 2 represents a situation in which the UE 20 is physically located in a foreign network outside of the home network 30. As shown, the wireless communication system 50 includes the UE 20, the foreign network 54 and the home network 30. In an exemplary embodiment, the foreign network 54 and the home network 30 are different types of networks. For example, the home network 30 may be a cellular network and the foreign network 54 may be a wireless local area network (WLAN) network, a WiMAX network or the like. In order for the UE 20 to obtain service in the foreign network 54, the UE 20 requires authentication in the foreign network 54. One way of performing this authentication based on GBA is to consider the NAF 34 to be in the foreign network 54, and the corresponding Ks_NAF will be used as the shared secret between the UE 20 and the foreign network 54. If a current shared secret (Ks) between the UE 20 and the NAF 34 of the home network is no longer valid, the UE 20 must request a bootstrapping process from the BSF 32 of the home network, typically by issuing an IP message to the BSF 32, to establish a new shared secret between the UE 20 and the BSF 32, which will be used to derive the required Ks_NAF as explained above.

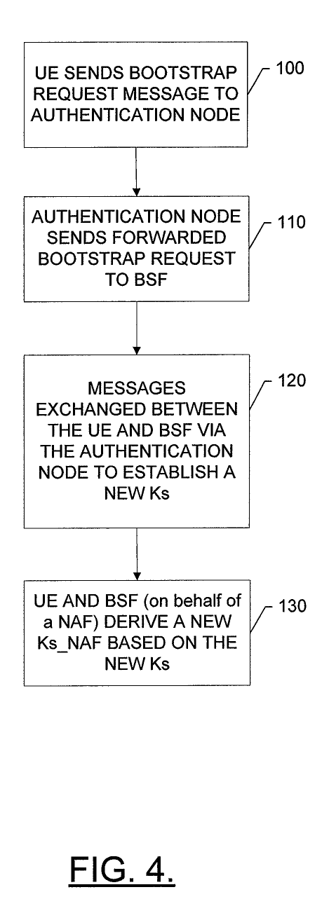

Since the UE 20 cannot establish an IP connection until the UE 20 has been authenticated (which (in the absence of embodiments of the present invention) will not be possible if re-keying is required), the UE 20 may send a message called a bootstrap request message 58 to the foreign network 54. See block 100 of FIG. 4. In an exemplary embodiment, the bootstrap request message 58 is submitted in the Extensible Authentication Protocol (EAP). EAP is a general authentication protocol that supports multiple authentication methods including, for example, traditional passwords, token cards, digital certificates and public-key authentication. An authentication node 60 of the foreign network 54 receives the bootstrap request message 58 from the UE 20 and forwards the bootstrap request message 58 as a forwarded bootstrap request 64 to the BSF 32 of the home network. See block 102 of FIG. 4. The bootstrap request message 58 includes, in addition to a bootstrap request, sufficient information to enable the authentication node 60 to identify the BSF 32 of the home network 30 that must be contacted in order to initiate the bootstrapping process. The forwarded bootstrap request 64 is protected using a trust relationship between the foreign network 54 and the home network 30. The trust relationship may be, for example, an existing relationship or a relationship established in response to receipt of the forwarded bootstrap request 64.

In response to receipt of the forwarded bootstrap request 64, the BSF 32 of the home network 30 continues with the bootstrapping procedure initiated by the forwarded bootstrap request 64 as if it were received directly from the UE 20 via the second interface Ub 44. The bootstrapping procedure consists of multiple messages exchanged between the UE 20 and the BSF 32 of the same type as in a conventional re-keying process that would be conducted if the UE 20 were in the home network 30 except in this case the messages are forwarded by the authentication node 60 in both directions. See block 104 of FIG. 4. Essentially, a “virtual” second interface Ub 44 is established by means of the authentication node 60 in the foreign network 54. In addition to a new Ks, this bootstrapping procedure that is facilitated by the authorization node also produces B-TID as well as the lifetime of the new Ks. Thus, once the UE 20 has been re-keyed, the new Ks can be used by the UE 20 and the BSF 32 of the home network 30 (on behalf of the NAF 34) to derive a new Ks_NAF, which can be used for mutual authentication between the UE 20 and the foreign network 54 during subsequent communication between the UE 20 and the foreign network 54. See block 106 of FIG. 4. In this regard, after receiving the new Ks, the UE 20 may be authenticated in the foreign network 54 using the new Ks_NAF derived from the newly generated Ks. One entity of the foreign network 54 (preferably, but not necessarily the authentication node 60) will take the role of a NAF. It is envisioned that any authentication mechanism may be used by the foreign network 54 for authenticating the UE 20 (and optionally authenticating the foreign network 54 to the UE 20), as long as the authentication is based on Ks_NAF.

In an exemplary embodiment, the authentication node 60 includes a processor and a memory device, which may either be dedicated to the authentication node or may be shared with other elements of the foreign network 54. The memory device is configured to store instructions for carrying out the above-described operations, while the processor is configured to retrieve and execute the instructions. In this regard, the processor generally includes the circuitry or other means necessary for implementing the functions of the authentication node and may be comprised of a digital signal processor, a microprocessor or other computing device.

It should be noted that the authentication node 60 of the foreign network 54 must be “GBA-aware”. In other words, the foreign network 54 must have nodes capable of parsing GBA signaling messages and acting in response to instructions contained in the GBA signaling messages. Furthermore, the authentication node 60 applies the above-described procedure regardless of which particular authentication mechanism is used in the bootstrapping procedure. Thus, the authentication node 60 described above is effective to translate EAP message based requests between the UE 20 and the BSF 32 for bootstrapping based on authentication and key agreement (AKA), SMEKEY and MN-AAA Key (SMEKEY and MN-AAA Key based bootstrapping are based on a password-protected Diffie-Hellman mechanism). For example, for bootstrapping based on AKA, one possible implementation of the EAP message could be based on EAP-AKA, in which EAP-AKA messages are used normally, but when EAP-Response/AKA-Challenge is received by an authenticator, an EAP-Request/AKA-Notification message is used to transfer a bootstrapping transaction identifier (B-TID) and a key lifetime to the UE 20. When the UE 20 receives the message, the UE 20 stores parameters received and replies with the EAP-Response/AKA-Notification message to acknowledge that the message was received.

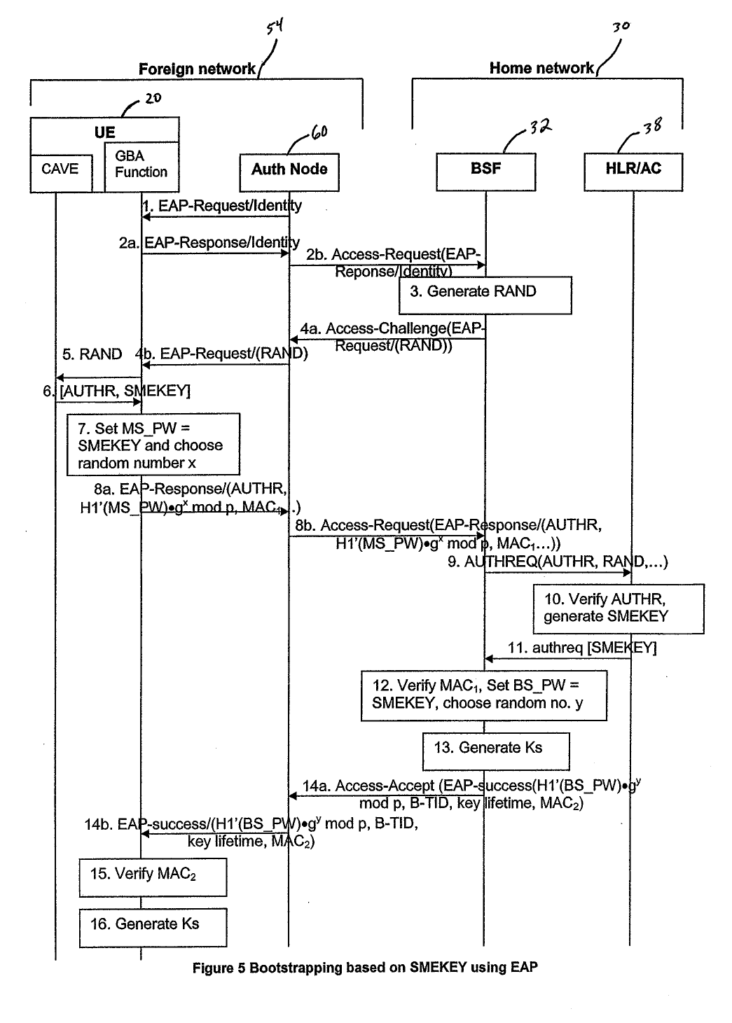

Bootstrapping based on SMEKEY is specified in section 4.5.2.1.1 and illustrated in Figure 4.4 in 3GPP2 specification S.P0109. One possible implementation of the EAP message is illustrated in FIG. 5, which resembles Figure 4.4 of S.P0109, except that instead of a direct HTTP connection between the UE 20 and the BSF 32 for bootstrapping, bootstrapping messages will be forwarded by the authentication node 60 in the foreign network 54. An interface between the UE 20 and the authentication node 60 is EAP, while an interface between the authentication node 60 and the BSF 32 may be, for example, RADIUS (as shown), DIAMETER protocol, or any other communication protocol. The authentication node 60 forwards EAP messaging from the UE 20 to the BSF 32 and vice versa. Note that in original bootstrapping (i.e. without an authentication node as described in the background section), message integrity of the Diffie-Hellman parameters and other payload information are protected by HTTP Digest Authentication. With EAP, a message authentication code MAC₁ can be computed by the UE 20 on information in a message that needs to be integrity protected, using SMEKEY as the key (in message 8 in FIG. 5). This MAC₁ is verified by the BSF 32 in step 12. In the reverse direction, a similar message authentication code MAC₂ can be computed by the BSF 32 on the information in the message that needs to be integrity protected, using SMEKEY as the key (in message 14a in FIG. 5). This is verified by the UE 20 in step 15.

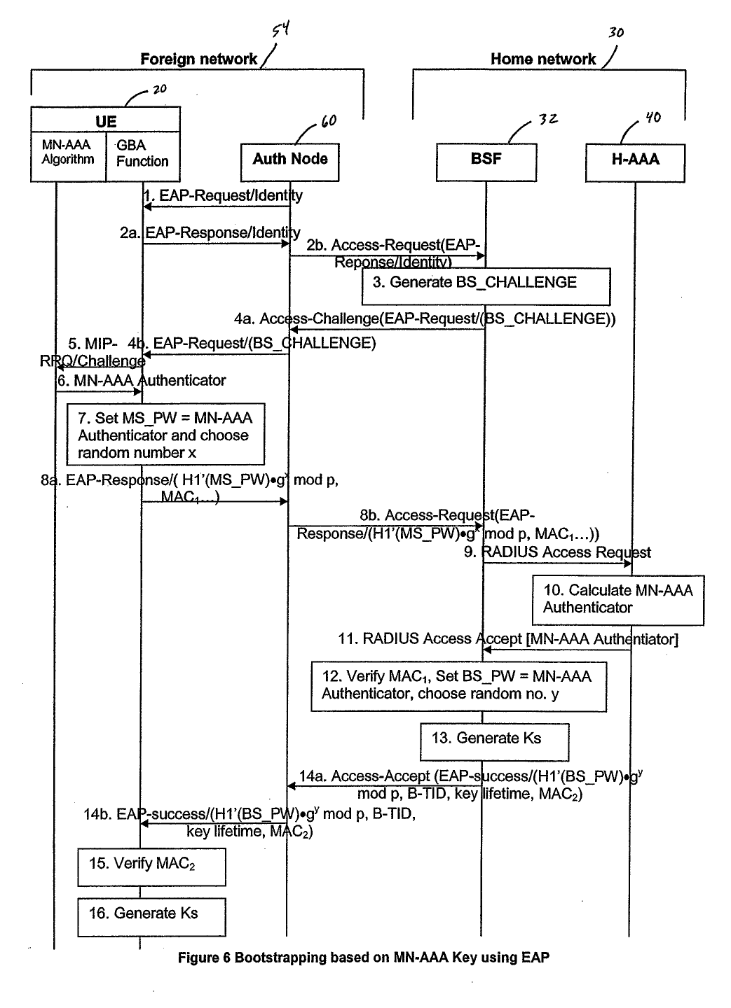

Similarly, bootstrapping based on MN-AAA Key is specified in section 4.5.2.1.2 and illustrated in Figure 4.5 in 3GPP2 specification S.P0109. One possible implementation of the EAP message is illustrated in FIG. 6, which resembles FIG. 4.5 of S.P0109, except that instead of a direct HTTP connection between the UE 20 and BSF 32 for bootstrapping, the bootstrapping messages will be forwarded by the authentication node 60 in the foreign network 54. The interface between the UE 20 and the authentication node 60 is EAP, while that between the authentication node 60 and the BSF 32 may be, for example, RADIUS (as shown), DIAMETER, or any other communication protocol. The authentication node 60 forwards EAP messaging from the UE 20 to the BSF 32 and vice versa. Note that in the original bootstrapping (i.e. without an authentication node as described in the background section), message integrity of the Diffie-Hellman parameters and other payload information are protected by HTTP Digest Authentication. With EAP, a message authentication code MAC₁ can be computed by the UE 20 on the information in the message that needs to be integrity protected using the MN-AAA Authenticator as key (in message 8 in FIG. 6). This MAC₁ is verified by the BSF 32 in step 12. In the reverse direction, a similar message authentication code MAC₂ can be computed by the BSF 32 on the information in the message that needs to be integrity protected, using the MN-AAA Authenticator as key (in message 14a in FIG. 6). This is verified by the UE 20 in step 15.

In an exemplary embodiment, the bootstrap request message 58 is submitted to the authentication node 60 as an IP message. In such a situation, the UE 20 may receive a temporary IP address enabling it to communicate with the authentication node 60 with IP messages. Because the UE 20 cannot communicate directly with the BSF 32 via IP messages until authentication is complete, the authentication node 60 receives the bootstrap request message 58 as an IP message. The bootstrap request message 58 includes an identity of the BSF 32 in the home network 30. Furthermore, in addition to the bootstrap request and identity information, the bootstrap request message 58 may further include a special code to indicate to the authentication node 60 that the bootstrap request message 58 contains a bootstrap request.

It is noted that while the authentication node 60 in the foreign network 54 permits communication between the mobile terminal 20 and the home network 30 for purposes of re-keying, the authentication node of one embodiment only permits communication between the mobile terminal and the home network for this specific limited purpose and not for other purposes, until that time that the mobile terminal has re-keyed and authenticated.

According to one exemplary aspect of embodiments of the invention, the functions performed by one or more of the entities of the system, such as the authentication node 60, the BSF 32, the NAF 34, the UE 20 or any of the other elements, may be performed by various means, such as hardware and/or firmware, including those described above, alone and/or under control of a computer program product. The computer program product for performing one or more functions of exemplary embodiments of the invention includes a computer-readable storage medium, such as the non-volatile storage medium, and software including computer-readable program code portions, such as a series of computer instructions, embodied in the computer-readable storage medium.

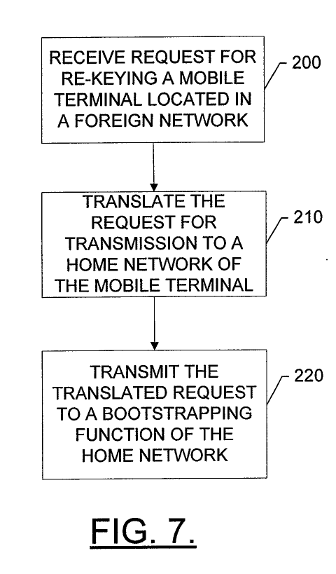

In this regard, FIGS. 4 and 7 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

As shown in FIG. 7, an exemplary method for re-keying a mobile terminal includes receiving a request for re-keying a mobile terminal in a foreign network at operation 200. At operation 210, the request is translated for transmission to a home network of the mobile terminal. At operation 220, the translated request is transmitted to a bootstrapping server function of the home network. Operation 200 may include receiving a bootstrap request requesting to commence a bootstrapping procedure in a first protocol such as, for example, EAP or IP. Operation 210 may include translating the request into a second protocol such as, for example, RADIUS, DIAMETER, or IP. Additionally, in exemplary embodiments, operation 200 may include receiving a request for bootstrapping based on a SMEKEY using EAP or based on MN-AAA Key using EAP.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving a request for re-keying a mobile terminal located in a foreign network;
translating the request for transmission to a home network of the mobile terminal; and
transmitting the translated request to a bootstrapping server function of the home network.

2. The method of claim 1, wherein receiving the request comprises receiving a bootstrap request requesting to commence a bootstrapping procedure in a first protocol.

3. The method of claim 2, wherein translating the request comprises translating the request into a second protocol.

4. The method of claim 3, wherein requesting to commence the bootstrapping procedure in the first protocol comprises one of:
requesting to commence the bootstrapping procedure in Extensible Authentication Protocol (EAP); or
requesting to commence the bootstrapping procedure in Internet Protocol (IP).

5. The method of claim 3, wherein translating the request into the second protocol comprises one of:
translating the request into Remote Authentication Dial In User Service (RADIUS);
translating the request into DIAMETER protocol; or
translating the request into Internet Protocol (IP).

6. The method of claim 1, wherein receiving the request includes receiving a request for bootstrapping based on a Signaling Message Encryption Key (SMEKEY) using Extensible Authentication Protocol (EAP).

7. The method of claim 1, wherein receiving the request includes receiving a request for bootstrapping based on a mobile node Authentication, Authorization, and Accounting (MN-AAA Key) using Extensible Authentication Protocol (EAP).

8. The method of claim 1, wherein receiving the request includes receiving a request for bootstrapping based on a mobile node Authentication and Key Agreement (AKA) using Extensible Authentication Protocol (EAP).

9. A computer program product comprising at least one computer-readable storage medium having computer-readable program code portions stored therein, the computer-readable program code portions comprising:
a first executable portion for receiving a request for re-keying a mobile terminal located in a foreign network;
a second executable portion for translating the request for transmission to a home network of the mobile terminal; and
a third executable portion for transmitting the translated request to a bootstrapping server function of the home network.

10. The computer program product of claim 9, wherein the first executable portion includes instructions for receiving a bootstrap request requesting to commence a bootstrapping procedure in a first protocol.

11. The computer program product of claim 10, wherein the second executable portion includes instructions for translating the request comprises translating the request into a second protocol.

12. The computer program product of claim 11, wherein the first executable portion includes instructions for receiving the bootstrap request requesting to commence a bootstrapping procedure in one of:
Extensible Authentication Protocol (EAP); or
Internet Protocol (IP).

13. The computer program product of claim 11, wherein the second executable portion includes instructions for translating the request into one of:
Remote Authentication Dial In User Service (RADIUS);
DIAMETER protocol; or
Internet Protocol (IP).

14. The computer program product of claim 9, wherein the first executable portion includes instructions for receiving a request for bootstrapping based on a Signaling Message Encryption Key (SMEKEY) using Extensible Authentication Protocol (EAP).

15. The computer program product of claim 9, wherein the first executable portion includes instructions for receiving a request for bootstrapping based on a mobile node Authentication, Authorization, and Accounting (MN-AAA Key) using Extensible Authentication Protocol (EAP).

16. The computer program product of claim 9, wherein the first executable portion includes instructions for receiving a request for bootstrapping based on a mobile node Authentication and Key Agreement (AKA) using Extensible Authentication Protocol (EAP).

17. An apparatus comprising a processor configured to:
receive, at the apparatus which is physically located in a foreign network, a request for re-keying from a mobile terminal in the foreign network;
translate the request for transmission to a home network of the mobile terminal; and
transmit the translated request to a bootstrapping server function of the home network.

18. The apparatus of claim 17, wherein the processor is further configured to receive a bootstrap request requesting to commence a bootstrapping procedure in a first protocol.

19. The apparatus of claim 18, wherein the processor is further configured to translate the request comprises translating the request into a second protocol.

20. The apparatus of claim 19, wherein the processor is further configured to receive the bootstrap request requesting to commence a bootstrapping procedure in one of:
Extensible Authentication Protocol (EAP); or
Internet Protocol (IP).

21. The apparatus of claim 19, wherein the processor is further configured to translate the request into one of:
Remote Authentication Dial In User Service (RADIUS);
DIAMETER protocol; or
Internet Protocol (IP).

22. The apparatus of claim 17, wherein the processor is further configured to receive a request for bootstrapping based on a Signaling Message Encryption Key (SMEKEY) using Extensible Authentication Protocol (EAP).

23. The apparatus of claim 17, wherein the processor is further configured to receive a request for bootstrapping based on a mobile node Authentication, Authorization, and Accounting (MN-AAA Key) using Extensible Authentication Protocol (EAP).

24. The apparatus of claim 17, wherein the processor is further configured to receive a request for bootstrapping based on a Authentication and Key Agreement (AKA) using Extensible Authentication Protocol (EAP).

25. A system comprising:
a mobile terminal physically located in a foreign network;
a bootstrapping server function in communication with a home network of the mobile terminal; and
an authentication node in communication with the foreign network, the authentication node configured to:
receive a request for re-keying from the mobile terminal;
translate the request for transmission the bootstrapping server function; and
transmit the translated request to the bootstrapping server function.

26. The system of claim 24, wherein the authentication node is further configured to receive the request comprising a bootstrap request for commencement of a bootstrapping procedure in a first protocol and to translate the request into a second protocol.

27. The system of claim 25, wherein the first protocol is one of:
Extensible Authentication Protocol (EAP); or
Internet Protocol (IP; and
wherein the second protocol is one of:
Remote Authentication Dial In User Service (RADIUS);
DIAMETER protocol; or
Internet Protocol (IP).

28. An apparatus comprising:
means for receiving a request for re-keying a mobile terminal located in a foreign network;
means for translating the request for transmission to a home network of the mobile terminal; and
means for transmitting the translated request to a bootstrapping server function of the home network.
